(19) United States
(12) Patent Application Publication
(10) Pub. No.: US 2015/0088539 A1
(43) Pub. Date: Mar. 26, 2015

(54) METHODS AND SYSTEMS FOR OPTIMIZING PATIENT ALLOCATION

(71) Applicant: Kyruus, Inc., Boston, MA (US)

(72) Inventors: Julie Keunhee Yoo, Boston, MA (US); Puneet Batra, Cambridge, MA (US); Vinay Seth Mohta, Newton, MA (US); John Martin Stogin, Princeton, NJ (US); Richard Won Park, Somerville, MA (US); Eliot James Knudsen, Cambridge, MA (US)

(21) Appl. No.: 14/492,566

(22) Filed: Sep. 22, 2014

Related U.S. Application Data
(60) Provisional application No. 61/881,010, filed on Sep. 23, 2013.

(51) Int. Cl. G06Q 10/06

(52) U.S. Cl. CPC G06Q 10/063118; G06Q 10/063114
USPC 705/2

(57) ABSTRACT

A method for optimizing patient allocation includes determining, by an analysis engine executing on a computing device, for a type of procedure, a total number of procedures performed by a plurality of physicians. The analysis engine determines a percentage of the total number of procedures performed by each of the plurality of physicians. The analysis engine determines whether the determined percentage for a first physician is lower than a threshold. The analysis engine determines whether the determined percentage for a second physician is lower than the threshold. An allocation engine executing on the computing device transitions responsibility for at least one procedure performed by the first physician to the second physician, responsive to a determination that the determined percentage for the first physician is lower than the threshold and that the determined percentage for the second physician is higher than the threshold.

### CROSS-REFERENCE TO RELATED APPLICATIONS

This application claims priority from U.S. Provisional Patent Application No. 61/881,010, filed on Sep. 23, 2013, entitled “Methods and Systems for Optimizing Patient Allocation,” which is hereby incorporated by reference.

### BACKGROUND

The disclosure relates to patient allocation. More particularly, the methods and systems described herein relate to optimizing patient allocation.

Conventional approaches to managing large groups of physicians do not typically provide functionality for making data-driven decisions regarding case management. This is due, in large part, to the fact that there is so much rapidly changing data, especially in groups including hundreds or thousands of physicians each with dozens or hundreds of patients and constantly seeking to grow their practices. Furthermore, each physician's workload is susceptible to change at any moment since multiple entities may be authorized to increase the workload—for example, one colleague may refer a patient to a specialist while an operator at a call center schedules a new patient to the same specialist and another operator makes an appointment with the specialist for an existing patient whose primary physician is unavailable, none of whom are required to confirm that the specialist is in fact the best person to treat their respective patients. It is therefore inefficient, if not completely infeasible, to manually receive an accurate portrayal of a particular physician's workload and analyze it in comparison to another physician without the resulting analysis being obsolete before it is even completed. To the extent that any human might attempt to manage the workload of a group of physicians, such humans typically use their own intuitions about whether a particular physician's workload is appropriate, not data resulting from scientific research.

However, given the nature of a physician's work, there may be serious, if not fatal, consequences to suboptimal patient allocation. Conventional groups of physicians typically suffer from long wait times for certain practitioners while other, potentially qualified, practitioners are underutilized. Under-qualified practitioners may suddenly face a heavy workload due to an influx of referrals but may not be able to receive the supervision needed to provide proper treatment, an especially serious issue given that research indicates that a minimum threshold of clinical fluency is critical in providing appropriate patient care.

### BRIEF SUMMARY

In one aspect, a method for optimizing patient allocation includes analyzing qualifications of physicians and determining whether to transition responsibility between physicians all in real-time and taking into account rapidly changing data sets. The method includes determining, by an analysis engine executing on a computing device, for a type of procedure, a total number of procedures performed by a plurality of physicians. The analysis engine determines a percentage of the total number of procedures performed by each of the plurality of physicians. The analysis engine determines whether the determined percentage for a first physician is lower than a threshold. The analysis engine determines whether the determined percentage for a second physician is lower than the threshold. An allocation engine executing on the computing device transitions responsibility for at least one procedure performed by the first physician to the second physician, responsive to a determination that the determined percentage for the first physician is lower than the threshold and that the determined percentage for the second physician is higher than the threshold.

In another aspect, a method for optimizing patient allocation includes determining, by an analysis engine executing on a computing device, for a type of procedure, a total number of procedures performed by a plurality of physicians. The analysis engine determines a percentage of the total number of procedures performed by each of the plurality of physicians. The analysis engine determines whether the determined percentage for a first physician is lower than a first threshold. The analysis engine determines that the determined percentage for a second physician is higher than the first threshold and lower than a second threshold. An allocation engine executing on the computing device transitions responsibility for at least one procedure performed by the first physician to the second physician, responsive to a determination that the determined percentage for the first physician is lower than the first threshold.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting one embodiment of a system for optimizing patient allocation;

FIG. 2B is a block diagram depicting one embodiment of a data structure generated by an analysis engine and storing determined calculations;

FIG. 3A is a flow diagram depicting one embodiment of a method for optimizing patient allocation; and

FIG. 3B is a flow diagram depicting another embodiment of a method for optimizing patient allocation.

### DETAILED DESCRIPTION

In some embodiments, the methods and systems described herein provide functionality for optimizing patient allocation. Before describing such methods and systems in detail, however, a description is provided of a network in which such methods and systems may be implemented.

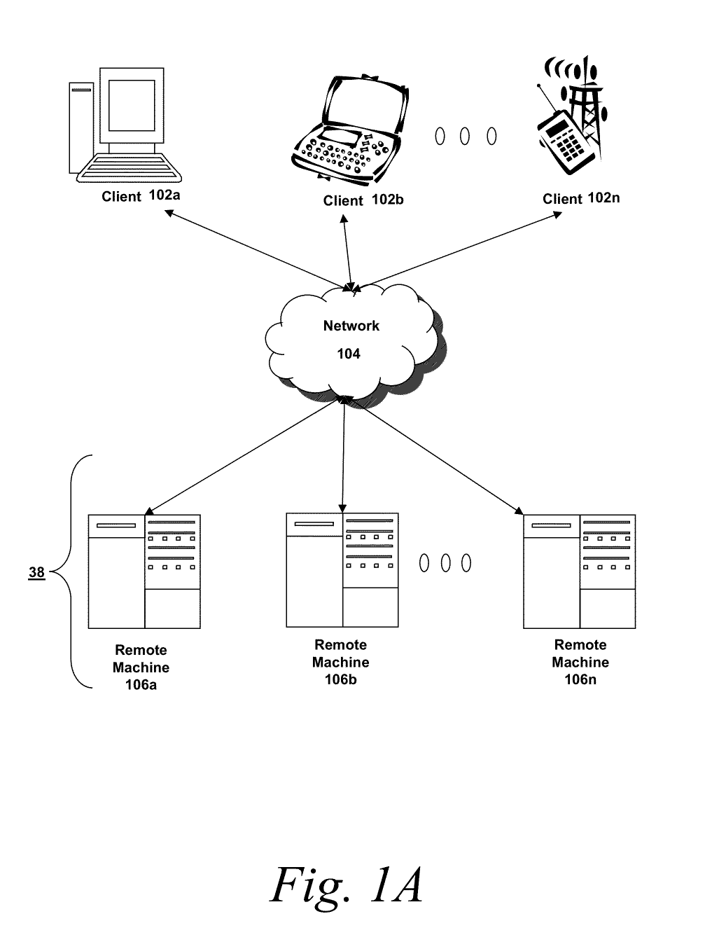

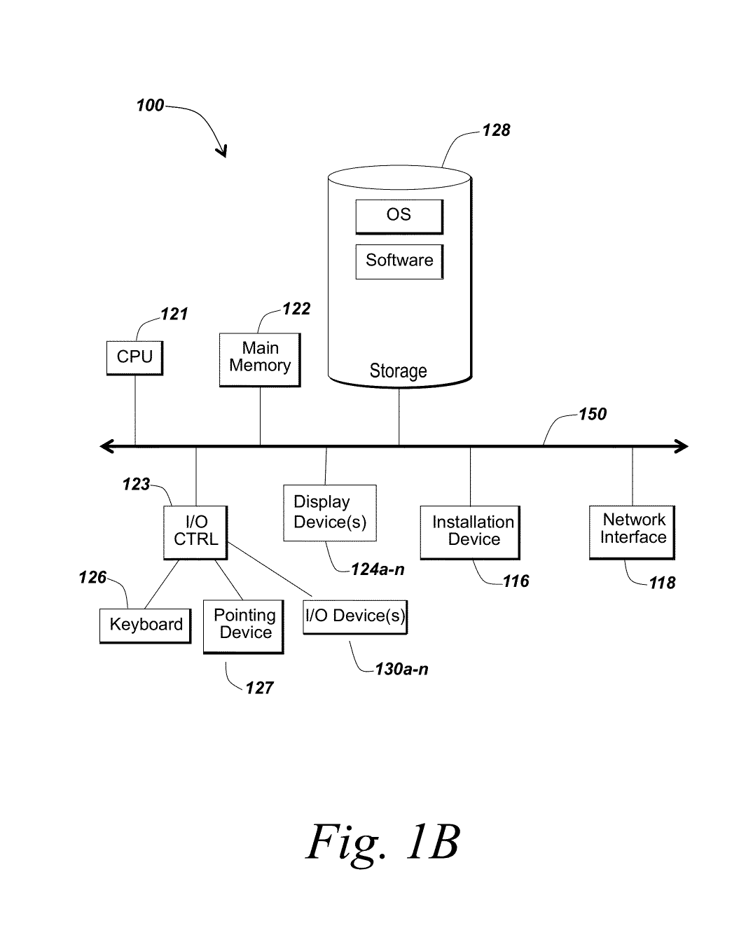

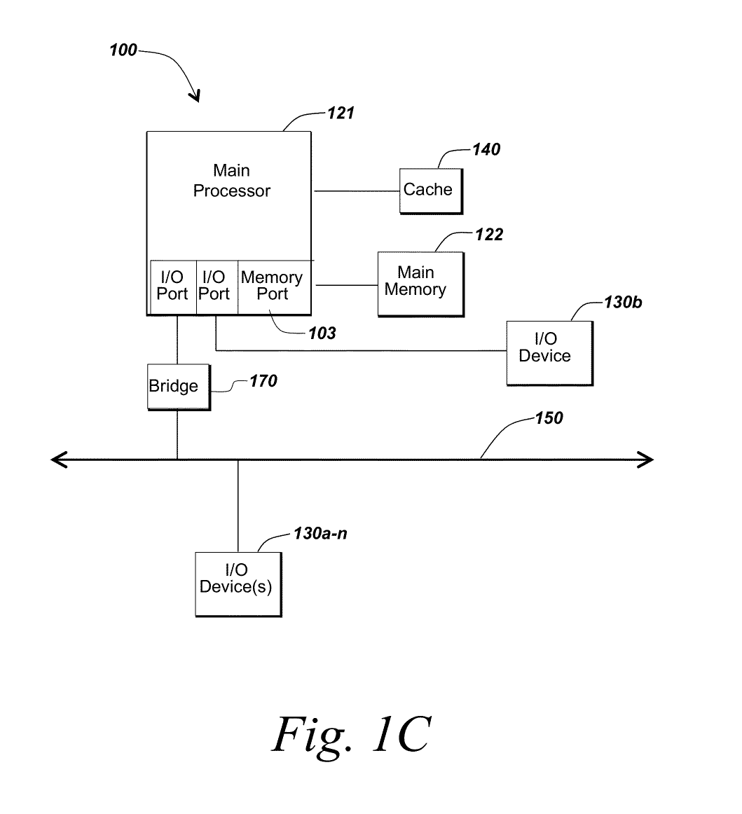

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch disks, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, of which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device.

In one aspect, the methods and systems described herein provide functionality for optimizing patient allocation. In one embodiment, the methods and systems described herein provide functionality for analyzing qualifications of physicians and determining whether to transition responsibility between physicians all in real-time and taking into account rapidly changing data sets.

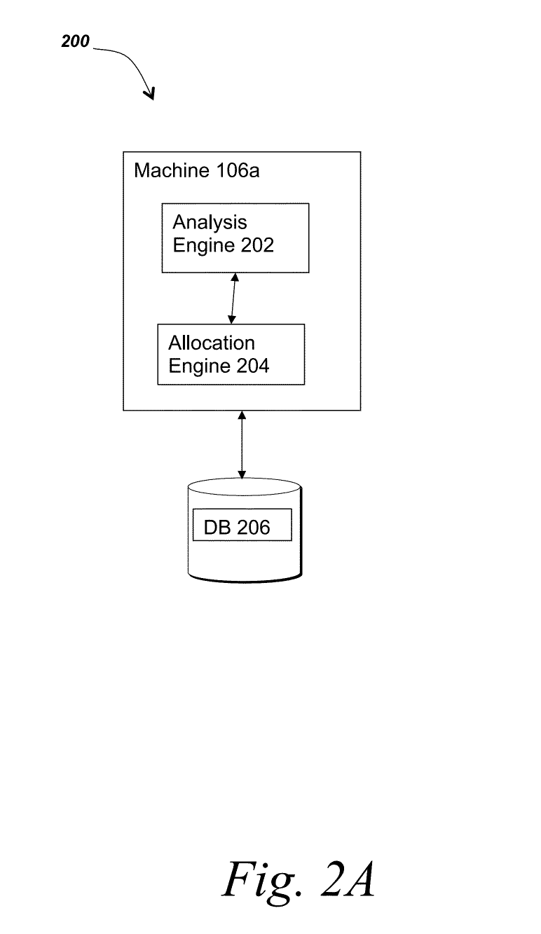

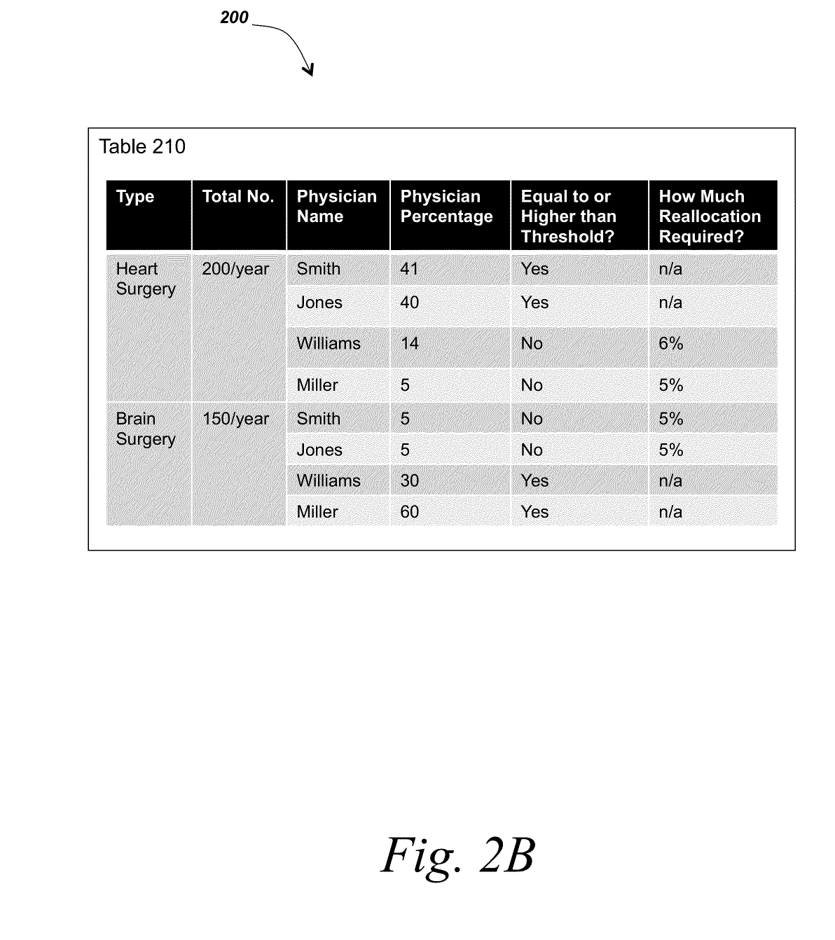

Referring now to FIG. 2A, a block diagram depicts one embodiment of a system for optimizing patient allocation. In brief overview, the system includes a machine 106a, an analysis engine 202, an allocation engine 204, and a database 206. In some embodiments, the machine 106a stores the database 206. In other embodiments, a second machine 106b (not shown) stores the database 206.

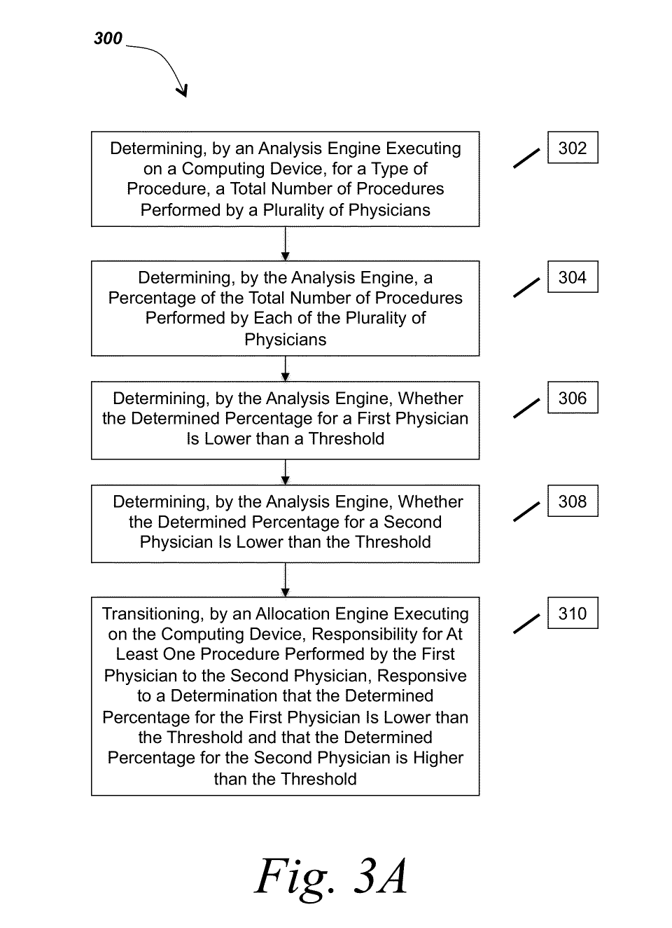

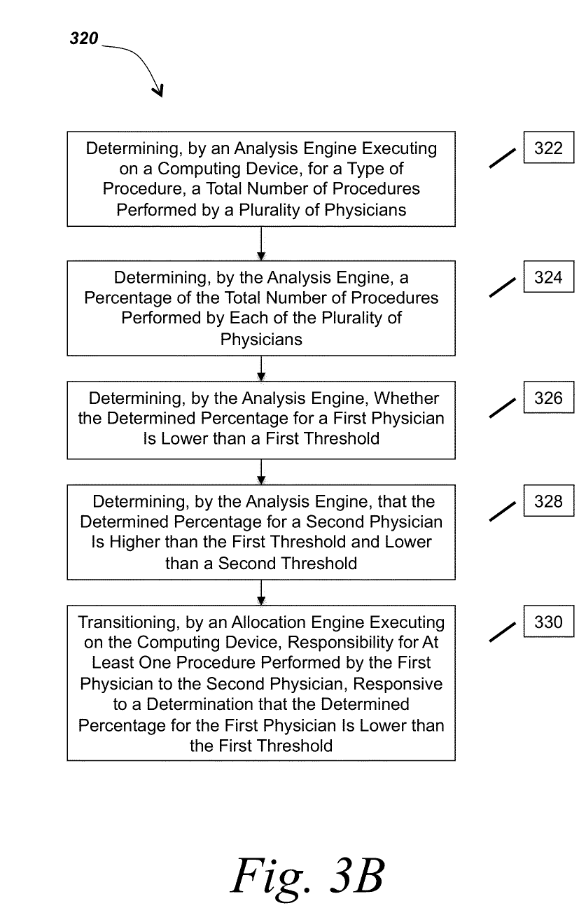

Referring now to FIG. 3A, and in connection with FIGS. 2A-2B, a flow diagram depicts one embodiment of a method 300 for optimizing patient allocation. In brief overview, the method 300 includes determining, by an analysis engine executing on a computing device, for a type of procedure, a total number of procedures performed by a plurality of physicians (302). The method 300 includes determining, by the analysis engine, a percentage of the total number of procedures performed by each of the plurality of physicians (304). The method 300 includes determining, by the analysis engine, whether the determined percentage for a first physician is lower than a threshold (306). The method 300 includes determining, by the analysis engine, whether the determined percentage for a second physician is lower than the threshold (308). The method 300 includes transitioning, by an allocation engine executing on the computing device, responsibility for at least one procedure performed by the first physician to the second physician, responsive to a determination that the determined percentage for the first physician is lower than the threshold and that the determined percentage for the second physician is higher than the threshold (310).

In more detail, the method 300 includes determining, by an analysis engine executing on a first computing device, for a type of procedure, a total number of procedures performed by a plurality of physicians (302). In one embodiment, an organization such as a hospital employs the plurality of physicians. Although the methods and systems described herein provide functionality applicable to organizations with any number of physicians, such methods and systems may be particularly helpful in managing organizations with large numbers of physicians. For example, some hospitals (or networks of affiliated hospitals) may employ hundreds or even thousands of physicians and implementing functionality for optimizing patient allocation may be particularly beneficial to such organizations.

In some embodiments, the healthcare organization employing the plurality of physicians provides the data analyzed by the analysis engine 202. In one embodiment, the analysis engine 202 accesses a scheduling database to determine the total number of procedures performed by the plurality of physicians. In another embodiment, the analysis engine 202 accesses an electronic medical record database to determine the total number of procedures performed by the plurality of physicians. In still another embodiment, the analysis engine 202 accesses a billing database to determine the total number of procedures performed by the plurality of physicians. In yet another embodiment, the analysis engine 202 accesses a claims database (e.g., a database of claims made to insurance companies for reimbursement) to determine the total number of procedures performed by the plurality of physicians.

In some embodiments, the analysis engine 202 accesses at least one database of procedure-related data, the at least one database undergoing modification by one or more entities. For example, a hospital may authorize the analysis engine 202 to access “live” databases such as scheduling databases that are actively used to create and modify scheduling data related to the type of procedure. Providing the analysis engine 202 with access to databases that are in use and subject to ongoing modification may allow the analysis engine 202 to make more accurate determinations than if the analysis engine 202 were restricted to historical data. In some embodiments, the analysis engine 202 receives access to both databases of historical data and to databases subject to ongoing modification.

In one embodiment, the analysis engine 202 accesses a database 206 to determine the total number of procedures of a particular type performed by the plurality of physicians. In another embodiment, the analysis engine 202 determines the total number of procedures of the type performed during a retrospective time period (e.g., the previous day, month, quarter, year, and so on). For example, the analysis engine 202 may retrieve data from the database 206 to determine how many heart surgeries all of the physicians at a particular hospital performed during the previous year. In another embodiment, the analysis engine 202 determines the total number of procedures of the type for which the plurality of physicians have contemporaneous responsibility (e.g., on-going cases or cases assigned to the physicians as of the date of the analysis). In still another embodiment, the analysis engine 202 determines the total number of procedures of the type for which the plurality of physicians will, prospectively, have responsibility (e.g., a number of cases assigned to the physicians as of the date of the analysis plus a prediction as to how many cases the physicians will have in a future time period). A user of the system 200 may specify the time period, the type of procedure, or other data used by the analysis engine 202 during execution of the optimization method.

The method 300 includes determining, by the analysis engine, a percentage of the total number of procedures performed by each of the plurality of physicians (304). In one embodiment, the analysis engine 202 determines the percentage of the total number of procedures performed by each physician. For example, the analysis engine 202 may determine that 200 heart surgeries were performed in the previous year and the analysis engine 202 may determine that Doctor Smith performed 25% of those 200 heart surgeries.

The analysis engine 202 may access data stored in the database 206 to make the determination. Data may include, without limitation, information associated with an organization (such as a hospital), information associated with a physician, diagnosis code(s), procedure code(s), cost of procedure, patient length of stay in the organization, a type of admittance to the organization (e.g., emergency or elective), and a financial class of a patient (e.g., self-pay or Medicare).

As shown in FIG. 2B, the analysis engine 202 may generate a table 210 or other data structure storing the determined total number and the determined physician percentages. In one embodiment, the analysis engine 202 makes the table 210 available to users of the system 200. By way of example, and as shown in FIG. 2B, the analysis engine 202 may determine that a plurality of physicians perform 200 heart surgeries a year and store that information in table 210. Continuing with this example, the analysis engine 202 may determine that one of the plurality of physicians (“Smith” in the embodiment depicted in FIG. 2B) performed 40% of the 200 total heart surgeries while determining that a second of the plurality of physicians (“Miller” in the embodiment depicted in FIG. 2B) performed 5% of the 200 total heart surgeries.

The method 300 includes determining, by the analysis engine, whether the determined percentage for a first physician is lower than a threshold (306). In some embodiments, a user specifies the threshold. In other embodiments, the analysis engine 202 specifies the threshold. In some embodiments, the threshold is a percentage of a number of procedures performed by a second physician. In one of these embodiments, by way of example, the threshold is 60% of the procedures performed by the most experienced physician in the plurality of physicians. For example, and referring again to FIG. 2B, Dr. Smith may be considered the most experienced physician for heart surgeries since she has performed a greater percentage of the 200 heart surgeries performed by the plurality of physicians than any of the other physicians. The threshold in such an example would therefore be 25% (e.g., 200*0.41 is 82 heart surgeries by Dr. Smith, 82*0.6=49 heart surgeries; 49/200=25%). In such an example, Dr. Jones would exceed the threshold since he has performed more than 25% of the total number of heart surgeries, but Drs. Williams and Miller would not meet the threshold.

As indicated above, in some embodiments, the threshold is specified as a relative value (for example, without limitation, a percentage of a number of another physician's procedures). In other embodiments, however, the threshold is a range of numbers. In still other embodiments, the threshold is a specific number. For example, either a user of the system 200 or an administrator of the analysis engine 202 may specify the number, or the analysis engine 202 may be configured to use a particular number during an initialization or configuration process.

In some embodiments, the threshold is a minimum clinical fluency threshold. In one of these embodiments, the threshold is determined based on scientific research focused on a particular type of procedure. In another of these embodiments, the threshold identifies a number of procedures below which it may be unsafe to have the physician perform the procedure. By way of example and without limitation, the user or the analysis engine 202 may access data (e.g., scientific research) to determine that when a physician performs less than 5% of the total number of procedures of a particular procedure type within a time period (e.g., a year), the quality of the physician's work suffers. Work quality may be determined by a user or by the analysis engine 202 and may be determined based on scientific research. For example, work quality may be determined based on how long a physician takes to complete a procedure, how well the patient recovers from the procedure, or how much the procedure costs. As another example, the analysis engine 202 may analyze medical data associated with procedures previously performed (e.g., billing data and insurance data) and determine that when physicians perform less than 5% of a total number of heart surgeries, each surgery costs more, the physicians take more time to complete the surgery, or the patient has an increased risk of dying.

In one embodiment, and as depicted in FIG. 2B, the analysis engine 210 may store an indication of whether the determined percentage for the first physician is lower than the threshold.

The method 300 includes determining, by the analysis engine, whether the determined percentage for a second physician is lower than the threshold (308). In one embodiment, the analysis engine 202 determines whether the determined percentage for the second physician is lower than the threshold as discussed above.

By way of example and without limitation, and referring again to FIG. 2B, in some embodiments, the analysis engine 202 may determine that a first physician's percentage falls below the threshold and that a second physician's percentage meets or exceeds the threshold (e.g., that Dr. Miller's percentage of a total number of heart surgeries performed in, for example, a year by Drs. Smith, Jones, Williams, and Miller falls below the threshold; and that Dr. Smith's percentage during a substantially similar time period meets or exceeds the threshold). Continuing with this example, the analysis engine 202 may determine that a number of cases currently assigned to the first physician (e.g., Dr. Miller) should be re-assigned to the second physician (e.g., Dr. Smith). The analysis engine 202 may determine that the first physician can complete certain procedures or patient-related activities based on an analysis of those procedures before the re-assignment (e.g., Dr. Miller may complete a post-operative treatment activity for a patient where she has already performed a surgery, but Dr. Smith should take over after completion of the treatment). Alternatively, the analysis engine 202 may determine to re-assign the first physician's procedure or activities as soon as practicable (e.g., if Dr. Miller has performed an initial evaluation of a patient and recommended a surgery, but has not yet scheduled the surgery, the analysis engine 202 may determine to re-assign the patient before the surgery). In other embodiments, the analysis engine 202 determines that a number of cases (e.g., patients or procedures) previously assigned to the first physician (e.g., in the last day, week, month, quarter, year, or other retrospective time period) fell below the threshold and that future cases that would have been assigned to the first physician should instead be assigned to the second physician (e.g., as opposed to determining that current caseload should be transitioned to the second physician as soon as practicable). The analysis engine 202 may determine that the first physician may continue his or her involvement in a procedure but under the supervision of the second physician. The analysis engine 202 may therefore determine to instruct the allocation engine to transition responsibility for at least one procedure. The analysis engine 202 may store an indication as to this determination; for example, the analysis engine 202 may store the indication in the table 210. In some embodiments, the analysis engine 202 transmits the indication to the allocation engine 204. In other embodiments, the allocation engine 204 retrieves the indication from the table 210.

The method 300 includes transitioning, by an allocation engine executing on the computing device, responsibility for at least one procedure performed by the first physician to the second physician, responsive to a determination that the determined percentage for the first physician is lower than the threshold and that the determined percentage for the second physician is higher than the threshold (310). In one embodiment, the allocation engine 204 receives, from the analysis engine 202, an instruction to transition responsibility for the at least one procedure. In one embodiment, the allocation engine 204 transitions responsibility for the procedures performed by the first physician to the second physician, responsive to a determination that the determined percentage for the first physician is substantially lower than the threshold and that the determined percentage for the second physician is substantially equal to or higher than the threshold. In some embodiments, the allocation engine 204 executes an algorithm for generating an optimal match between each of a number of physicians and an amount of available work. For example, the allocation engine 204 may determine to move a patient from an unqualified first doctor (e.g., a first doctor that did not substantially meet the threshold) to a more qualified second doctor (e.g., a second doctor that did substantially equal or exceed the threshold). As another example, the allocation engine 204 may determine to move a patient from a first doctor to a second doctor who is at least one standard deviation more experienced. In some embodiments, and as will be discussed in further detail in connection with FIG. 3B, the allocation engine 204 then determines that the second doctor has too much work and reallocates the second doctor's work to a third doctor, repeating until the allocation engine 204 has addressed each of the plurality of physicians.

The allocation engine 304 may transmit, to a scheduling component (not shown), an instruction to modify a database entry identifying the first physician as responsible for the at least one procedure. The allocation engine 304 may transmit, to an electronic medical record management component (not shown), an instruction to modify a database entry identifying the first physician as responsible for the at least one procedure.

In one embodiment, the allocation engine 204 reallocates the procedures assigned to each of the plurality of physicians so that each procedure is assigned to a more qualified physician. In another embodiment, the allocation engine 204 is constrained by the physicians' capacity.

In one embodiment, the allocation engine 204 identifies a plurality of patients (e.g., patients associated with a procedure) for whom a more experienced physician is available. In another embodiment, for each patient, the allocation engine 204 identifies at least one doctor with more experience than the patient's current doctor and attempts to find an allowable path from the patient's current doctor to the at least one doctor; an allowable path may, for example, be a path from doctor to doctor to doctor in a plurality of available doctors, such that each doctor has a patient that is allowed to be seen by the next doctor in the path. In one embodiment, the search for the path is a breadth-first search. In some embodiments, once the allocation engine 204 identifies an allowable path, each of the plurality of patients is reallocated to the new doctors in the path. If a second patient is moved to a better physician during the course of reallocating a first patient through an allowable path, the second patient is removed from the plurality of patients for whom a more experienced physician is available.

In some embodiments, the allocation engine 204 executes a version of the Gale-Shapley algorithm or other algorithm for solving the “stable marriage problem.” In other embodiments, the allocation engine 204 executes an algorithm to optimize an existing pairing between available work and available physicians, as opposed to using the algorithm to create an initial pairing between available work and available physicians. In other embodiments, the allocation engine 204 executes an algorithm to ensure an optimized pairing of existing work and available physicians before assigning new work to the available physicians. In other embodiments, the allocation engine 204 specifies that the algorithm generating the optimal match should determine how to allocate work amongst the plurality of physicians such that the percentage of the total amount of work falls substantially at the specified threshold for each physician.

In some embodiments, the allocation engine 204 may execute a secondary algorithm for reallocation. For example, if no optimal reallocations are available amongst physicians (e.g., the second physician recommended by the initial algorithm has too great a workload to take on the reallocation and there are no third physicians who could take on the overflow), the allocation engine 204 may identify a second-best physician based on weaker matching criterion. As another example, the allocation engine 204 may determine that, based on relative experience, although a second physician would be ideal, a third physician with less experience than the second has more experience than the first physician. For example, referring to FIG. 2B, although the allocation engine 204 may primarily seek to reallocate work from Dr. Miller to Dr. Smith, if Dr. Smith cannot take on any additional procedures, patients, or other tasks, the allocation engine 204 may reallocate Dr. Miller's work to Dr. Jones who has also exceeded the threshold, although not by as much as Dr. Smith. As another example, the allocation engine 204 may seek to allocate a subset of the work (e.g., particular visit types) for which it can identify a suitable physician to which to reallocate the subset.

The system 200 may further execute a method to modify a previous optimization. Therefore, in one embodiment, the methods described herein include determining, by the analysis engine, that data relating to the total number of procedures has changed; automatically re-determining, by the analysis engine, whether the determined percentage for the first physician is lower than the threshold; automatically re-determining, by the analysis engine, whether the determined percentage for the second physician is lower than the threshold; and determining, by the analysis engine, whether to instruct the allocation engine to modify an identification of a physician responsible for the at least one procedure, based upon the re-determinations. Due to the system 200 functionality for continuously re-evaluating types of procedures and patient allocation data for each physician in a plurality of physicians, updating and modifying transitions of responsibility as appropriate, the system 200 may be said to operate in real-time.

In one embodiment, the analysis engine 202 and the allocation engine 204 operate automatically in order to dynamically identify procedures for which responsibility should be transferred from one physician to another. In addition to executing the methods described herein for each physician in a plurality of physicians once and identifying an optimal patient allocation for one patient or procedure at one point in time, the analysis engine 202 and the allocation engine 204 may continue executing the methods described herein and continually identify increased optimizations. By way of example, by the time the system 200 has completed identifying and transitioning responsibility for a first procedure or plurality of physicians, the data underlying those determinations may have been modified such that a new set of optimizations should be implemented. By continuously executing and by accessing active databases continuously susceptible to modification, the system 200 may provide automatic updates to optimizations, keeping pace with changes implemented at the organization of physicians.

Referring now to FIG. 3B, and in connection with FIGS. 2A-2B, a flow diagram depicts an embodiment of a method 320 for optimizing patient allocation. In brief overview, the method 320 includes determining, by an analysis engine executing on a computing device, for a type of procedure, a total number of procedures performed by a plurality of physicians (322). The method 320 includes determining, by the analysis engine, a percentage of the total number of procedures performed by each of the plurality of physicians (324). The method 320 includes determining, by the analysis engine, whether the determined percentage for a first physician is lower than a first threshold (326). The method 320 includes determining, by the analysis engine, that the determined percentage for a second physician is higher than the first threshold and lower than a second threshold (328). The method 320 includes transitioning, by an allocation engine executing on the computing device, responsibility for at least one procedure performed by the first physician to the second physician, responsive to a determination that the determined percentage for the first physician is lower than the first threshold (310).

The method 320 includes determining, by an analysis engine executing on a computing device, for a type of procedure, a total number of procedures performed by a plurality of physicians (322). In one embodiment, the analysis engine 202 performs this determination as described above in connection with FIG. 3A.

The method 320 includes determining, by the analysis engine, a percentage of the total number of procedures performed by each of the plurality of physicians (324). In one embodiment, the analysis engine 202 performs this determination as described above in connection with FIG. 3A.

The method 320 includes determining, by the analysis engine, whether the determined percentage for a first physician is lower than a first threshold (326). In one embodiment, the analysis engine 202 performs this determination as described above in connection with FIG. 3A.

The method 320 includes determining, by the analysis engine, that the determined percentage for a second physician is higher than the first threshold and lower than a second threshold (328). In some embodiments, in addition to determining whether a physician is qualified (e.g., has seen enough patients to meet a quality threshold and will continue seeing those patients instead of having the patients reallocated to more qualified physicians), the analysis engine 202 determines whether the physician is seeing too many patients. For example, the analysis engine 202 may determine whether the physician has too large a percentage of the total number of procedures for any other physician to develop expertise in handling the type of the procedure. The analysis engine 202 may determine the second threshold based on user input to the system 200.

The method 320 includes transitioning, by an allocation engine executing on the computing device, responsibility for at least one procedure performed by the first physician to the second physician, responsive to a determination that the determined percentage for the first physician is lower than the first threshold (330). In one embodiment, the allocation engine 204 performs this determination as described above in connection with FIG. 3A.

In some embodiments, implementation of the methods and systems described herein may result in a system that accounts for a volume of work done by an organization (e.g., a hospital) and by members of the organization (e.g., a plurality of physicians at the hospital). In one of these embodiments, allocation of work to particular physicians may take into account whether the physician has a threshold level of experience in performing the work, instead of merely considering availability of the physician.

Although the embodiments described herein relate to optimization of allocations in a medical setting, one of ordinary skill in the art will understand that the methods and systems described herein may also relate to other industries. For example, management consultants, attorneys, salespeople, or other professionals may also have workloads optimized.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. A computer may also receive programs and data from a second computer providing access to the programs via a network transmission line, wireless transmission media, signals propagating through space, radio waves, infrared signals, etc.

Having described certain embodiments of methods and systems for optimizing patient allocation, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for optimizing patient allocation determining, by an analysis engine executing on a computing device, for a type of procedure, a total number of procedures performed by a plurality of physicians;
determining, by the analysis engine, a percentage of the total number of procedures performed by each of the plurality of physicians;
determining, by the analysis engine, whether the determined percentage for a first physician is lower than a threshold;
determining, by the analysis engine, whether the determined percentage for a second physician is lower than the threshold; and
transitioning, by an allocation engine executing on the computing device, responsibility for at least one procedure performed by the first physician to the second physician, responsive to a determination that the determined percentage for the first physician is lower than the threshold and that the determined percentage for the second physician is higher than the threshold.

2. The method of claim 1 further comprising accessing, by the analysis engine, a scheduling database to determine the total number of procedures performed by the plurality of physicians.

3. The method of claim 1 further comprising accessing, by the analysis engine, an electronic medical record database to determine the total number of procedures performed by the plurality of physicians.

4. The method of claim 1 further comprising accessing, by the analysis engine, a billing database to determine the total number of procedures performed by the plurality of physicians.

5. The method of claim 1 further comprising accessing, by the analysis engine, a claims database to determine the total number of procedures performed by the plurality of physicians.

6. The method of claim 1 further comprising analyzing, by the analysis engine, at least one database of procedure-related data, the at least one database undergoing modification by one or more entities.

7. The method of claim 1 further comprising:
determining, by the analysis engine, that data relating to the total number of procedures has changed;
automatically re-determining, by the analysis engine, whether the determined percentage for the first physician is lower than the threshold;
automatically re-determining, by the analysis engine, whether the determined percentage for the second physician is lower than the threshold; and
determining, by the analysis engine, whether to instruct the allocation engine to modify an identification of a physician responsible for the at least one procedure, based upon the re-determinations.

8. The method of claim 1 further comprising determining, by the analysis engine, to instruct the allocation engine to transition responsibility for the at least one procedure.

9. The method of claim 1 further comprising receiving, by the allocation engine, from the analysis engine, an instruction to transition responsibility for the at least one procedure.

10. The method of claim 1, wherein transitioning further comprises transmitting, to a scheduling component, an instruction to modify a database entry identifying the first physician as responsible for the at least one procedure.

11. The method of claim 1, wherein transitioning further comprises transmitting, to an electronic medical record management component, an instruction to modify a database entry identifying the first physician as responsible for the at least one procedure.

12. A method for optimizing patient allocation
determining, by an analysis engine executing on a computing device, for a type of procedure, a total number of procedures performed by a plurality of physicians;
determining, by the analysis engine, a percentage of the total number of procedures performed by each of the plurality of physicians;
determining, by the analysis engine, whether the determined percentage for a first physician is lower than a first threshold;
determining, by the analysis engine, that the determined percentage for a second physician is higher than the first threshold and lower than a second threshold; and
transitioning, by an allocation engine executing on the computing device, responsibility for at least one procedure performed by the first physician to the second physician, responsive to a determination that the determined percentage for the first physician is lower than the first threshold.

13. The method of claim 12 further comprising accessing, by the analysis engine, an electronic medical record database to determine the total number of procedures performed by the plurality of physicians.

14. The method of claim 12 further comprising accessing, by the analysis engine, a billing database to determine the total number of procedures performed by the plurality of physicians.

15. The method of claim 12 further comprising analyzing, by the analysis engine, at least one database of procedure-related data, the at least one database undergoing modification by one or more entities.

16. The method of claim 12 further comprising:
determining, by the analysis engine, that data relating to the total number of procedures has changed;
automatically re-determining, by the analysis engine, whether the determined percentage for the first physician is lower than the threshold;
automatically re-determining, by the analysis engine, whether the determined percentage for the second physician is lower than the threshold; and
determining, by the analysis engine, whether to instruct the allocation engine to modify an identification of a physician responsible for the at least one procedure, based upon the re-determinations.

17. The method of claim 12 further comprising determining, by the analysis engine, to instruct the allocation engine to transition responsibility for the at least one procedure.

18. The method of claim 12 further comprising receiving, by the allocation engine, from the analysis engine, an instruction to transition responsibility for the at least one procedure.

19. The method of claim 12, wherein transitioning further comprises transmitting, to a scheduling component, an instruction to modify a database entry identifying the first physician as responsible for the at least one procedure.

20. The method of claim 12, wherein transitioning further comprises transmitting, to an electronic medical record management component, an instruction to modify a database entry identifying the first physician as responsible for the at least one procedure.
